(19) United States
(12) Patent Application Publication
(10) Pub. No.: US 2003/0120758 A1
(43) Pub. Date: Jun. 26, 2003

(54) XML conditioning for new devices attached to the network

(75) Inventors: Amr Yassin, Ossining, NY (US); Yasser Alsafadi, Yorktown Heights, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/028,381

(22) Filed: Dec. 21, 2001

(51) Int. Cl. G06F 15/177; G06F 15/16

(52) U.S. Cl. 709/221; 709/203

(57) ABSTRACT

The invention relates to a method of and system for recognizing the device format preference for excerpted electronic program guide information for a device on an IHDN network. The device connects to the network, which has an XML data repository. An XSL stylesheet request for excerpted EPG information, including a device format preference, is sent from the device over the IHDN network to an XSLT engine in communication with the XML data repository. The device format preference from the XML data repository on the network is used so that the network can recognize the device. It also further relates to repository, formatting the excerpted EPG information in accordance with the data format preference of the device, and sending the excerpted EPG information by the XSLT engine to the device over the IHDN network.

### FIELD OF THE INVENTION

The invention relates to a method and system for providing needed items from a document to a device on a network. In particular, the invention relates to the device requesting needed items from an XML document using an extensible style sheet.

### BACKGROUND OF THE INVENTION

Devices such as televisions, personal computers (PCs), video cassette recorders (VCRs), etc. have been enabled to communicate over a communications network with servers and other devices. Often, such devices share or download data of various formats, such as Extensible Markup Language (XML) documents.

XML was first designed as a complete, platform-independent and system-independent environment for the delivery and authoring of information resources over the World Wide Web (hereinafter, “Web”). XML was intended to supplement and in some cases replace Hypertext Markup Language (HTML), which had been the prevalent method of authoring and referencing content over the Web.

XML is a set of technologies that define a universal data format for tree-based, hierarchically formed information. A number of new specifications extending its range and power, such as Extensible Stylesheet Language (XSL) and XSL Transformations (XSLT), are being developed or have already been developed.

Documents in XML format may be stored in an XML database (also called an “XML data repository”). Such a database or repository can be made accessible over a network, such as the Internet, or even over an In-Home Digital Network (IHDN). An IHDN is a network environment in which one or more of the clients (if a client-server networking model is employed) are PCs, personal digital assistant (PDAs), televisions, VCRs, personal video recorders (PVRs), remote controls, audio systems, or other devices, typically used for entertainment and other purposes, usually in a home.

Information in XML format can be delivered over a network by a server to a client. Such information, for example an electronic programming guide (EPG) or other data useful to the client or to the client's user, may be stored in an XML database. Currently, typical servers provide the requested information to typical clients as XML documents. For example, the server on an IHDN can provide the EPG in XML format for either the TV, VCR, PVR, or remote control.

In order for the server to provide the correct XML content to each client, the server must be configured in advance to accommodate the required XML format for every client requesting the data. For example, in a typical home digital network wherein the server is providing the EPG data for different devices, each device may have different ability to handle an XML document or different set of information from an XML repository. Thus, while one device might be able to process a full EPG in XML format, a device with a lesser processing and memory capacity might only be able to handle the textual information within an XML document. There are presently two ways for sharing any XML document with devices having different requirements:

Send the whole document to every device; or

The server has to be configured before-hand for every device on the network in order to be able to serve it.

Both of these methods have problems. The first approach requires that each device receives and processes the entire XML document. This requires that the device have a lot of processing power and memory. The device, however, might have only a limited amount of processing power and/or memory.

Thus, there is a desire for a method of and system for delivering only the parts of an XML document to a device in a format useable by the device, based on the needs and capability of the device. This would allow a device with limited processing capability to download only the portion af a particular document needed in a format the device is able to process.

The second approach is a problem when a new device is attached to the network for the first time. The server must be configured for the new device so that it knows what parts of the XML document should be sent to the new device. This is an especially relevant problem with Universal Plug-N-Play (“UPNP”) networks, wherein clients are frequently connected and disconnected from the network.

Therefore, there is a desire for a method of and system for informing the server what parts of an XML document and in what format a device requires when the device is attached to the network.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

To achieve these and other advantages and in accordance with the purpose of the invention, as embodied and described, the invention includes a method of recognizing a data format preference of a device. First, the device is connected to a network having a data repository, at which time a device format preference is sent to the data repository. Next, the device format preference from the data repository on the network is used to allow the network to recognize the device.

In another embodiment, the device format preference is alternatively sent to the data repository each time the device requests specific information. In this embodiment it is not necessary that the device format preference be sent to the data repository at the time the device is connected to the network.

Another embodiment of the current invention includes further sending a request for specific information by the device. Next, the specific information is extracted from a data storage by the data repository, formatted according to the device format preference retrieved from the data repository and sent to the device over the network. In a preferred embodiment the device format preference is retrieved from the data repository a device identifier.

In another embodiment, a method of recognizing a device format preference for excerpted electronic program guide information of a device on an IHDN network having an XML data repository is provided. First, the device is connected to the network and an XSL stylesheet request for excerpted EPG information, including a device format preference from the device, is sent over the IHDN network to an XSLT engine in communication with the XML data repository. Next the device format preference from the XML data repository on the network is used so that the network can recognize the device.

The invention also includes a system for recognizing a data format preference of a device. The system includes a network that includes a data repository, the device with the data format preference connected to the network, an a data packet containing a request for specific information that includes the device format preference. The data packet is prepared by the device and transmitted over the network to the data repository of the network, which stores the device format preference, so that the network can recognize the device.

In another embodiment, the data repository further extracts the specific information of the request, formats the specific information in accordance with the device data format preference, and transmits the specific information over the communication network to the device.

It is understood that both the foregoing general description and the following detailed description are exemplary and are intended to provide further explanation of the invention claimed.

The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF DRAWINGS

FIG. 1 is a schematic diagram of the method and system of a preferred embodiment of the current invention;

FIG. 2 is a schematic of the functioning of a extensible style sheet transformation process, such as used in a preferred embodiment of the current invention; and

FIG. 3 is a schematic diagram of the method and system of a preferred embodiment of the current invention wherein an extensible style sheet transformation engine is employed.

### DETAILED DESCRIPTION OF THE PREFERRED EMBODIMENTS

The following description is presented to enable any person of ordinary skill in the art to make and use the present invention. Various modifications to the preferred embodiment will be readily apparent to those of ordinary skill in the art, and the disclosure set forth herein may be applicable to other embodiments and applications without departing from the spirit and scope of the present invention and the claims hereto appended. Thus, the present invention is not intended to be limited to the embodiments described, but is to be accorded the broadest scope consistent with the disclosure set forth herein.

In accordance with the present invention, a system and method for XML conditioning for new devices attached to a network by recognizing a data format preference for the device on the network is provided. A preferred embodiment of the current invention provides for the network to recognize the data format preference of the device at the time the device is initially connected, and to save this information, preferably using a device identifier. The use of a device identifier is not mandatory, and other methods of saving the device data format preference are known in the art.

For purpose of illustration, and not limitation, the method and system embodied herein are directed to the delivery of parts of an XML document to a device, based on the needs and capability of the device and in a format useable to the device. This allows a device with limited processing capability to download only the portion of a particular XML document needed in a format the device is able to process. Although a preferred embodiment of the current invention refers to XML documents, it may be applied to documents in any format, as is understood in the art.

Additionally, the current invention provides a method of and system for informing a server what parts of an XML document and in what format a device in communication with the server over a network requires when the device is attached to the network. In particular, since the current invention envisions informing the server of the document format desired at the time each request for documents is made, there is no longer a need to notify the server of the document formats supported by a device when it is first attached to the network. Moreover, the current invention provides for requests for specific information by a device be filled by a data depository on the network. The filling of the request preferably involves the functions of retrieving the device format preference, formatting the specific information requested according to this preference, and sending the formatted information to the device.

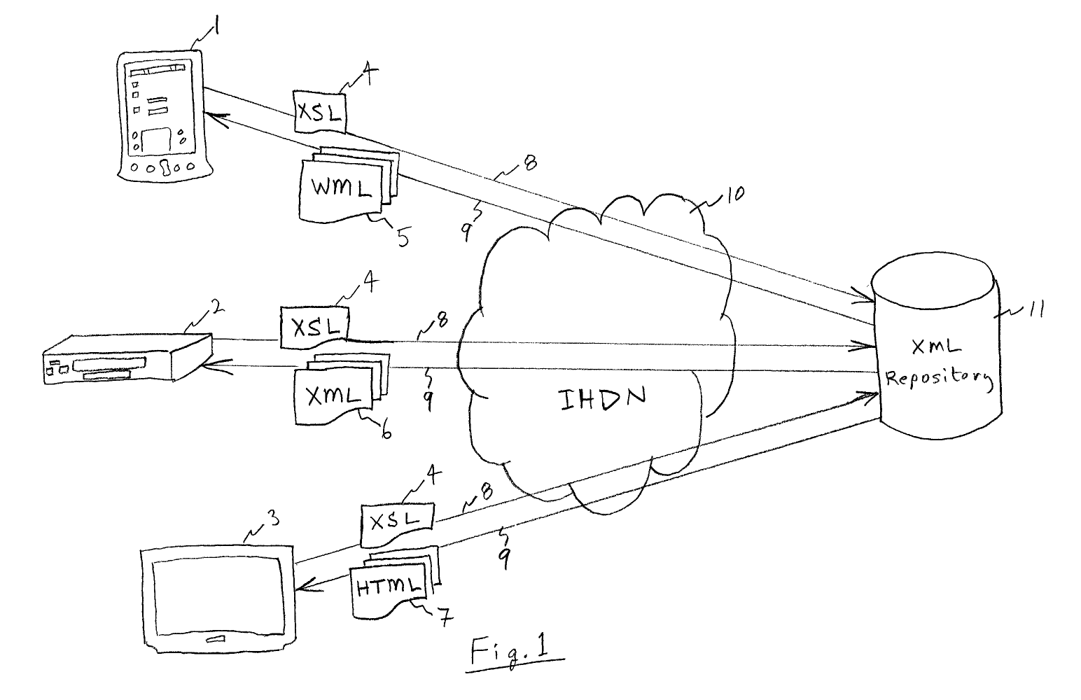

FIG. 1 is a schematic diagram of the method and system of a preferred embodiment of the current invention. An XML repository 11, contains XML documents. The repository 11 may include a database of XML documents, together with the necessary storage and retrieval hardware and software for maintaining and allowing access to the XML documents stored therein. For example, the XML documents may be stored in a repository 11 containing a disk drive storage for storing the documents and a computer with database, interface and networking software for accessing and communicating the stored documents.

A client device, such as the PC 1, VCR 2, television 3 or any other device sends an extensible stylesheet 4 (XSL) to the XML repository 11 over a network, such as the IHDN 10 depicted. The device can be any equipped to communicate an XSL 4 over the network. The XSL 4 may include information regarding the XML document or documents needed by the device, as well as the format required by the device. The XML repository 11 can then deliver the required document in any supported format.

Although an XSL 4 is used by a preferred embodiment of the invention to inform the XML repository of the precise XML document or portion thereof and the format requested by the device, any other data structure or file may be used, provided it contains the required information. For example, a device requesting a full XML document may request it by specifying only the XML document name. Alternatively, a complex data structure may be required to request several portions from several XML documents to be delivered in an alternative format, such as text.

Three formats are depicted for the return document, wireless markup language 5 (WML), XML 6, and HTML 7. Other document types may be supported, such as text, PDF, and many others. The use of the three formats here is for illustrative purposes, not intended to limit the formats supportable by the current invention. Moreover, the return of an HTML 7 document to the television 3, an XML 6 document to the VCR 2, and a WML 5 document to a personal digital assistant 1, is not intended to suggest that these document types are always requested by the respective device. Any device may request and use a document in any supported format.

The XSL 4 may then be used at the XML repository 11 to extract the information requested by the device, in the format requested. The extraction process may be accomplished by several alternative methods, including the use of an extensible stylesheet transformation (XSLT) engine in conjunction with conventional database techniques, as described below. The XML repository 11 may consist of a database containing XML documents, together with the database retrieval software necessary to retrieve the XML document requested, or portion thereof. Alternatively, the complete XML document may be extracted, and any subset created during a separate formatting step.

Next, the XML repository 11 may send the retrieved document over the communication network, here the IHDN 10, to the requesting device. There the device can use the retrieved document. An example of a use by a device of information retrieved from an XML document is the downloading of EPG information to a VCR 2. An EPG typically contains a large quantity of information regarding available programming, such as the date, time, name, actors, brief synopsis, scenes etc. for an upcoming televised program. A VCR 2 may not have the capacity or the need for all this information. Alternatively, the VCR 2 may not have the processing capability to parse and use an XML document. Thus, the VCR 2 may request only a portion of an XML EPG formatted as a plain text file.

In another embodiment, a personal digital assistant (PDA) device might request only the text portion of an XML-formatted Internet page, due to bandwidth and display constraints. Alternatively, a high definition television (HDTV) device might request the full XML EPG, since it might have greater processing and memory capability.

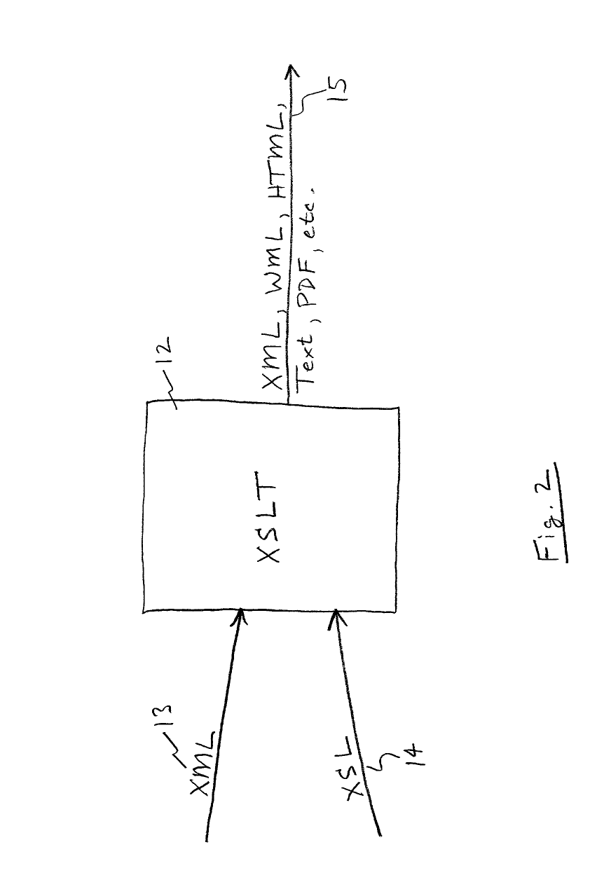

FIG. 2 is a schematic of an XSLT process, such as used in a preferred embodiment of the current invention. An XSLT engine 12 accepts as input an XSL 14 and an XML document 13. In more detail, an XSLT engine 12 optionally and preferably can first accept the XSL 14. The identification of the XML document can be sent along with the XSL 14 document, or done beforehand. The XSLT engine 12 could then query a database of XML documents to retrieve the XML document requested (step not depicted). After the retrieval of the XML document, the XSLT engine 12 may then parse the XML document to extract the portion requested, and format the extracted portion as specified in the XSL 14.

The format of the extracted portion of the XML document produced 15 by the XSLT engine 12 may be any format, XML, WML, HTML, text, PDF, or any other format, as specified in the XSL 14. In an embodiment, the XSLT engine 12 can also return the full original XML document without alteration or filtering.

In another embodiment, the XSLT engine 12 is packaged with the XML repository 11 in the system as depicted in FIG. 1, thereby forming a part of the XML repository 11. For example, an embodiment of an XML repository 11 may include an XML database, using standard database software, such as structured query language (SQL) and the database itself, and hardware, such as a common network server. These components may then be in communication with an XSLT engine 12, which may execute on the same server.

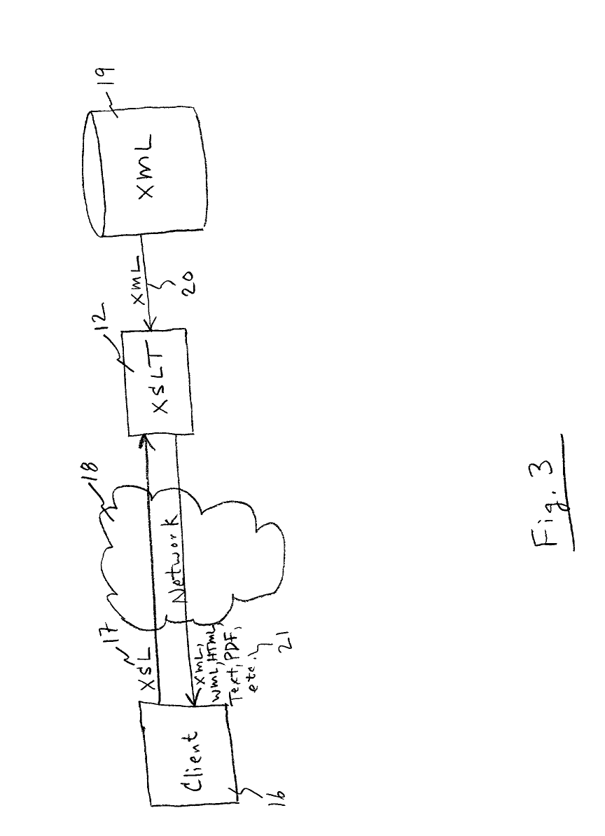

In another embodiment, the XSLT engine 12 and the other components of the XML repository can be located on different physical servers in communication with each other. FIG. 3 depicts such a scenario. The device, here referred to as client 16, sends the XSLT engine 12 an XSL 17, which is then parsed to determine the XML document requested by the client 16. The XSLT engine 12 next queries the XML database 19 to retrieve the requested XML document 20. The XSLT engine 12 then parses the XML document so retrieved to extract and format the requested information. This information is then sent to the client device 21.

As another example, a cellular telephone device may request to retrieve a portion of an XML document for an Internet page resembling a telephone book in a format supported by the cellular telephone, such as wireless internet protocol (WAP). This format typically requires that many of the features used and available in XML documents be stripped or filtered out, or compressed, to facilitate the limited display, memory and communication bandwidths characteristic of cellular telephone technology. The device would then prepare and send, over a communications network, to the XML repository, an XSL requesting the portion of the XML telephone directory Internet page document in a WAP format. The XSLT engine associated with the XML repository then queries the associated XML document database to retrieve the XML document, extracts and formats the requested portion of the XML document in the requested WAP format, and returns this WAP document to the cellular telephone device over the communications network.

Alternatively, another embodiment provides that the XML repository itself handles the request from a device for formatted XML documents or portions thereof without the use of a formal XSLT engine. The request from the device does not necessarily have to be formatted as an XSL, but may be any format. It is preferable that the format identify the XML document, or portion thereof, to be retrieved, and format required.

It will be apparent to those skilled in the art that various modifications and variations can be made in the method and system of the present invention without departing from the spirit and scope of the invention. Thus, it is intended that the present invention include modifications and variations that are within the scope of the appended claims and their equivalents.

What is claimed is:

1. A method of recognizing a data format preference of a device, comprising the steps of
connecting a device to a network having a data repository;
sending a device format preference to the data repository of the network when the device is connected to the network; and
utilizing the device format preference from the data repository on the network, so that the network can recognize the device.

2. The method of claim 1, which further comprises saving the device format preference in the data repository.

3. The method of claim 1, wherein the device format preference is sent with a device identifier.

4. The method of claim 1, wherein the device format preference is saved with a network address of the device to be used as a device identifier by the data repository.

5. The method of claim 1, wherein the device connected to the network sends the device format preference each time it is connected to the network.

6. The method of claim 1, wherein the network is automatic configuration network, so that any device connected thereto sends the device format preference upon initial connection to the network.

7. The method of claim 1, further comprising the steps of
sending a request for specific information by the device;
extracting specific information from a data storage by the data repository;
retrieving the device format preference by the data repository using the device identifier;
formatting the specific information according to the device format preference; and
sending the specific information to the device from the data repository over the network.

8. The method according to claim 7, wherein the device is an electronic device and the request for the specific information and device format preference are in the form of one or more data packets.

9. The method according to claim 7, wherein the data repository is an extensible Markup Language (XML) data repository.

10. The method according to claim 7 wherein the data repository includes an XML database in communication with an Extensible Stylesheet Transform (XSLT) engine in communication with the network.

11. The method according to claim 7, wherein the request for information is in an XSL stylesheet.

12. The method according to claim 7, wherein the network is an IHDN.

13. The method according to claim 7, wherein the device is any one of the group comprising a personal computer, personal digital assistant, television, video cassette recorder, personal video recorder, remote control, and audio system, and the specific information requested is electronic program guide information.

14. A method of recognizing a device format preference for excerpted electronic program guide information of a device on an IHDN network, the method comprising the steps
connecting the device to the network that has an XML data repository;
sending an XSL stylesheet request for excerpted EPG information, including a device format preference from the device over the IHDN network to an XSLT engine in communication with the XML data repository; and
utilizing the device format preference from the XML data repository on the network, so that the network can recognize the device.

15. The method of claim 14, further comprising
extracting the requested excerpted EPG information by the XSLT engine from the XML data repository;
formatting the excerpted EPG information in accordance with the data format preference of the device; and
sending the excerpted EPG information by the XSLT engine to the device over the IHDN network.

16. A system for recognizing a data format preference of a device, the system comprising
a network that includes a data repository;
the device connected to the network, wherein the device has a data format preference;
a data packet containing a request for specific information that includes the device format preference, wherein the data packet is prepared by the device and transmitted over the network to the data repository of the network;
the data repository stores the device format preference, so that the network can recognize the device.

17. The system of claim 16, further comprising
the data repository extracts the specific information of the request, formats the specific information in accordance with the device data format preference, and transmits the specific information over the communication network to the device.

18. The system according to claim 16, wherein the data repository is an XML data repository, which includes an XML database in connection with an XSLT engine, and the request for specific information and the device format preference are in an XSL stylesheet.

19. The system according to claim 16, wherein the network is an IHDN.

20. The system according to claim 16, wherein the specific information requested is electronic programming guide information.
